(19) United States
(12) Patent Application Publication
(10) Pub. No.: US 2015/0087259 A1
(43) Pub. Date: Mar. 26, 2015

(54) PERSON AND PROPERTY PROTECTION SYSTEM AND METHOD

(71) Applicant: ULTRAVEX TRADING LLC, HEREDIA (CR)

(72) Inventor: Otmar HINSEN, Hamburg (DE)

(73) Assignee: ULTRAVEX TRADING LLC, HEREDIA (CR)

(21) Appl. No.: 14/245,496

(22) Filed: Apr. 4, 2014

(30) Foreign Application Priority Data
Sep. 20, 2013 (DE) 20 2013 008 368.9

(51) Int. Cl. H04W 4/22

(52) U.S. Cl. CPC H04W 4/22
USPC 455/404.2

(57) ABSTRACT

A person and property protection system has a portable handheld transmitter, a control center comprising a receiving unit for receiving the emergency call signal from the handheld transmitter with a localization unit designed to determine a location of the handheld transmitter and a communication unit which is designed to inform an emergency service. A signal transmitted to the emergency service comprises details of the handheld transmitter and its location. The control center is provided with a person protection module and a property protection module. The communication unit is connected at least to the person protection module. The property protection module features an uplink interface which is designed to transmit blocking signals to financial institutions and further a downlink interface which is designed to send protection signals to a home base of the handheld transmitter.

### REFERENCE TO RELATED APPLICATIONS

This application claims priority to German application no. 20 2013 008 368.9 , filed Sep. 20, 2013, the entire contents of which is incorporated herein by reference.

### FIELD OF THE INVENTION

The invention relates to a person and property protection system and method having a portable handheld transmitter for a person to be protected, said transmitter having at least one trigger and a transmitting unit for transmitting an emergency call signal to a control center, a control center having a receiving unit for receiving the emergency call signals from the handheld transmitter and a localization unit which is designed to determine the location of the handheld transmitter, and also a communication unit for informing at least one emergency service.

### BACKGROUND OF THE INVENTION

Many variations of systems for protecting persons or property are known. They are generally used to quickly provide an alarm in emergency situations, in particular with respect to a risk to life and limb of persons or the destruction, theft or robbery of property.

These systems are mainly distinguished by whether they are primarily used to protect persons or property. Portable and stationary systems are known in the case of person protection systems. The stationary system generally contains call systems which are connected to the telephone network in a person's household. The person to be protected can transmit an emergency call by operating a corresponding trigger button on the stationary device. In addition, provision is often made in this case for there also to be a handheld transmitter, with the result that the emergency call can also be transmitted by the person to be protected at any desired location inside the house. Portable person protection systems are primarily geared to use outside the person's own house. Such systems are used, in particular, to trigger SAR (Search and Rescue) services and are widespread, in particular, among sailors or in other outdoor activities. Their functionality lies in the fact that an emergency call which can be located is reported and the person transmitting the emergency call can be found, for example using satellite positioning.

Systems have also become known which use a positioning service such as GPS and have a communication unit, for example via a mobile radio service. Such devices are often structurally combined and can be carried by a person to be monitored or can be arranged on a property item to be monitored. The systems continuously detect their position and transmit it to a predefined receiver at regular intervals. Conversely, it is also possible for the devices to be queried from the outside and for the devices to communicate their position in the process. Such systems are known as tracking systems, in particular of vehicles, such as loads with valuable cargo, or of persons in need of help, in particular children or persons with dementia.

Although there are a multiplicity of different monitoring systems, none is equally suitable for comprehensive protection of persons and property items, to be precise also in the case of attacks or robbery.

### SUMMARY OF THE INVENTION

An object of the invention is to provide an improved protection system of the type mentioned at the outset which avoids the abovementioned disadvantages.

This can be achieved according to the invention by a system and method having the features as broadly disclosed herein. The detailed embodiments described below relate to advantageous developments.

In a person and property protection system having at least one portable handheld transmitter, a control center and a communication unit, wherein the handheld transmitter is assigned to a person to be protected and has at least one trigger and a transmitting unit for transmitting an emergency call signal to the control center, and the control center comprises a receiving unit for receiving the emergency call signals from the handheld transmitter and a localization unit which is designed to determine a location of the handheld transmitter, and wherein the communication unit is designed to inform an emergency service, a signal being transmitted to the emergency service, which signal comprises details of the handheld transmitter and its location, the invention provides for the control center to have a person protection module and a property protection module, the communication unit being connected at least to the person protection module, and the property protection module having an uplink interface which is designed to transmit blocking signals to financial institutions and also a downlink interface which is designed to transmit protection signals to an individually assigned home base.

A few of the terms used are first of all explained below.

A handheld transmitter is understood as meaning a unit which is carried by or worn on a person. It is highly mobile, similar to a wristwatch, but need not necessarily be worn on the arm or carried in the hand. It may likewise be a buckle-on unit, a hanging unit (for example around the neck) or a unit which is directly connected to the body.

An emergency service is understood as meaning public or private services, for example a security service, the police or fire department.

A financial institution is understood as meaning banks or credit card companies (or other institutions having assets belonging to the person to be protected).

The invention is based on the concept of achieving comprehensive protection by combining person protection and property protection using suitable modules. This is based on the knowledge that an attack on a person is sometimes not aimed at all at the person himself but rather only at acquiring property items belonging to said person or else vice versa. An integrated design of the two types of protection for persons, on the one hand, and property items, on the other hand, can therefore result in increased security for both. A symbiotic effect therefore results. This applies, in particular, when, as a result of an attack on a person for example, the person's accounts are automatically blocked by virtue of financial institutions being informed using the property protection module. The attackers can therefore no longer reach the bank assets of the person to be protected, to be precise not even when they force this person to release signatures, PIN numbers or other access codes with the threat of violence. Threatening the person to be protected is therefore fruitless. On the contrary, as a result of the combination with the person protection system, the emergency service, in particular the police, is alerted, to be precise irrespective of whether or not a property item has actually been seized.

Such symbiotic linking of person and property protection does not have an example in the prior art.

The handheld transmitter advantageously has a sensor for detecting vital states (for example a pulse sensor) and an automatic switch which automatically activates the emergency signal when certain conditions occur. Special protection results for the person to be protected since manual triggering is therefore no longer absolutely necessary. If the vital state is impaired, an emergency call can be automatically transmitted thanks to the automatic switch.

A standby switch with an expiration timer and a cancel button can also be provided on the handheld transmitter. In this case, the standby switch and the expiration timer interact in such a manner that, after the standby switch has been operated, the emergency signal is automatically triggered after expiry of the duration set by the expiration timer. The handheld transmitter can therefore be changed to a type of “armed” state from which it automatically forwards the alert if the cancel button has not previously been pressed. This is suitable, for example, for protection in the case of explorations, at the start of which the standby switch is operated and the emergency call signal is automatically transmitted when the person to be protected does not safely report back (by operating the cancel button) within a predetermined duration of 5 to 10 minutes, for example. This can also be combined with the vital state sensor. For example, a heightened state of excitement (in a threat scenario) may result in the standby switch being activated, with the result that an emergency call is automatically transmitted after the preset duration if it is not manually canceled. Automatic signaling can therefore also be achieved in the event of surprising situations.

The handheld transmitter can have a plurality of input switches for signaling different types of emergency calls. Different emergency call signals can therefore be signaled, for example theft, burglary or else kidnapping (abduction). Thanks to such different signaling, it is possible to respond in an adapted manner and approaching emergency service personnel are already aware of the situation. In this case, it is particularly expedient if the plurality of input switches can be operated by a common operating knob. This considerably simplifies the user interface and, on the other hand, makes it possible to miniaturize the handheld transmitter. The latter increases the portability of the handheld transmitter and thus improves the protection efficiency since a highly portable handheld transmitter is carried more often than a handheld transmitter which is difficult to carry.

It is particularly expedient if the handheld transmitter is integrated in a wristwatch with a telephone function. In this manner, the telephone function of the wristwatch can be used as a transmitter unit for transmitting an emergency call. Since the handheld transmitter is therefore situated in the wristwatch, no further item needs to be carried by the person to be protected.

The control center is expediently of two-part design with a control subcenter at the home location of the person to be protected (home base). This means that the control subcenter is arranged on the estate belonging to the person to be protected. This shortens the signaling distance for the handheld transmitter, with the result that less powerful handheld transmitters are also sufficient for this purpose. This may also be used for redundancy, with the result that, for those cases in which the handheld transmitter no longer reaches the (main) control center, signaling to the control subcenter which is nevertheless still possible suffices to trigger the emergency call. The control subcenter is advantageously connected to the control center via at least two independent communication paths. In this case, at least one of the two communication paths is wireless and at least one other of the two communication paths is wired. This means that it is possible to communicate with the control center even when there is an attack on a cable connection, for example by cutting the telephone lines. Conversely, as a result of the wired connection, communication can take place even when the mobile radio network has interference, for example as a result of jammers (GSM jammers). It is expedient to conduct wired communication using separate wiring, rather than the telephone network.

With particular advantage, the download interface is designed to communicate with the immobilizer of a motor vehicle and block said immobilizer using a protection signal. The immobilizer of the motor vehicle can therefore be activated, for example, in response to the transmission of an emergency call. Theft of the motor vehicle is therefore thwarted. This therefore also prevents stolen goods or abduction with the motor vehicle belonging to the person to be protected. It goes without saying that, in the case of a plurality of motor vehicles in the household of the person to be protected, a plurality or all of these motor vehicles are also accordingly controlled by the download interface.

The download interface can also be designed to transmit a silent warning signal to the home base. Signaling can therefore be effected on the estate belonging to the person to be protected. This can be in the entrance area of the estate. It is therefore possible to signal to family members returning home that there is an emergency in the house. The signaling expediently differs depending on the type of emergency. For a more medical emergency involving the person to be protected, use is therefore made of a different signal to that used for an attack on the person, for example in the event of robbery or abduction. In the last case in particular, this avoids family members returning home from being concomitantly involved in the act.

The invention further relates to a corresponding method for person and property protection.

### BRIEF DESCRIPTION OF THE DRAWINGS

The invention is explained in more detail below using an exemplary embodiment and with reference to the accompanying drawing, in which:

FIG. 1 shows an overview illustration of the system;

FIG. 2 shows an illustration of the handheld transmitter; and

FIG. 3 shows an alternative design for the handheld transmitter.

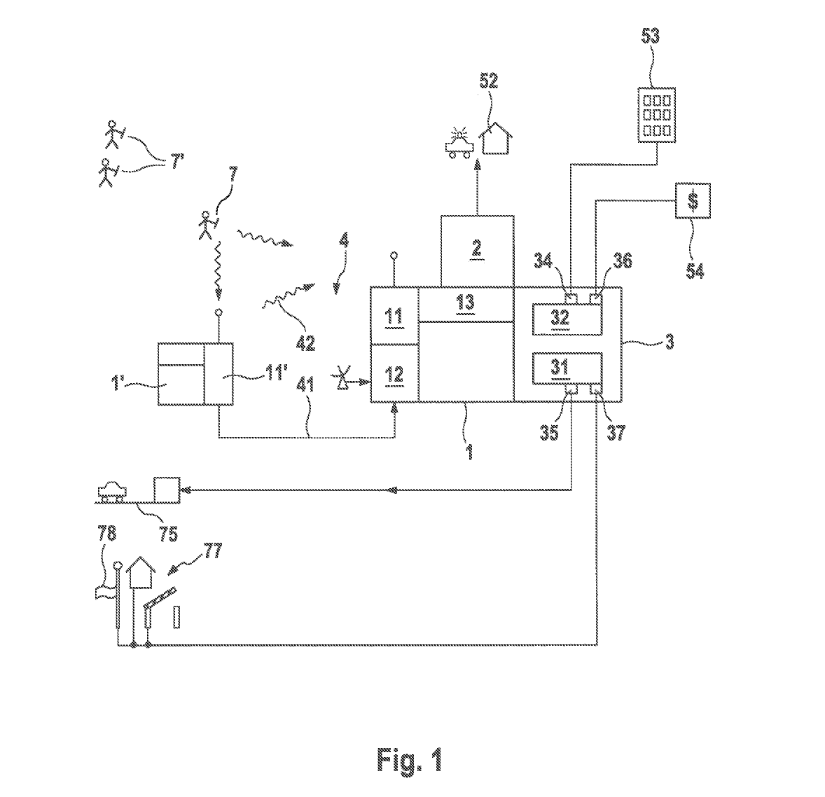

### DETAILED DESCRIPTION OF THE INVENTION

An exemplary embodiment of a person and property protection system according to the invention, as illustrated in the figures, comprises, as the core pieces, a control center 1 and a handheld transmitter 7 assigned to a person to be protected. The handheld transmitter 7 is provided with a transmitting unit 71 which can be used to transmit an emergency signal to the control center 1. The control center 1 which can be a security service control center staffed around the clock is provided with a corresponding receiving unit 11 for receiving the emergency call signal. The central unit 1 therefore receives the emergency call signal and moves an emergency service 52 and/or carries out further protection measures. This is explained in yet more detail further below.

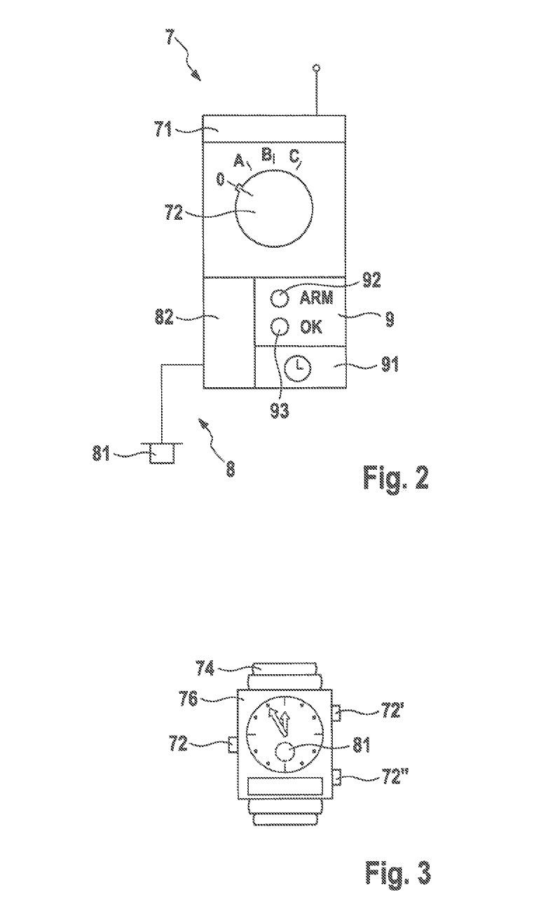

The handheld transmitter 7 has at least one input switch 72 which can be used to trigger the emergency call signal. The input switch 72 may be of multilevel design or a plurality of input switches 72, 72′, 72″ may be provided in order to be able to generate and transmit different types of emergency call signals in this manner. The handheld transmitter 7 illustrated in FIG. 2 is provided with an optional vital state detector 8. The latter comprises a pulse sensor 81, the signals from which are checked and classified using an evaluation unit 82. A distinction is made according to whether the measured pulse signals correspond to those of a healthy living person. If not, this is considered to be an acute threat to the person to be protected and the handheld transmitter 7 is controlled by the evaluation unit 82 in such a manner that an emergency call signal is transmitted via the transmitting unit 71.

The handheld transmitter 7 also has a standby sensor 9 with an expiration timer 91. The standby mode sensor is activated using an operation knob 92 and is changed to an “armed state”, and the expiration timer 91 is started. The armed state is retained until either the expiration timer 91 has expired or a cancel button 93 is operated. In the last-mentioned case, that is to say upon operation of the cancel button 93, the person to be protected confirms, by said operation, that he is well and there is no longer a threat situation. The armed state is therefore left. However, in the first-mentioned case, if the cancel button 93 has not been operated and the time preset by the expiration timer 91 has elapsed, an acute threat situation is assumed and the handheld transmitter 7 uses the transmitting device 71 to transmit the emergency call signal to the control center 1. Thanks to the latter device, the person to be protected can, for example set off on an exploratory tour and, at the start, changes the handheld transmitter 7 to the armed state in this case; if the person returns safely, the cancel button 93 is operated. If something happens to the person on the way and the cancel button 93 is therefore not operated, the handheld transmitter 7 causes the emission of the emergency call after the preset period of time in the expiration timer 91.

The control center 1 may optionally be of two-part design with a control subcenter 1′. This can be a detached control unit which is expediently arranged on the estate belonging to the person to be protected (home base). It expediently has its own receiving device 11′ by means of which it can likewise receive the signals emitted by the handheld transmitter 7 and transmits them to the main control center 1 via an independent connection 4. The independent connection 4 can be of two-channel design with a wired connection 41 and a radio link 42. This results in increased transmission security and even better protection against manipulation, for example caused by damage to the telephone network or by possible use of jammers. The wired connection 41 can be designed to be separate from a telephone connection using separate dedicated cabling which is laid in a protected manner.

In addition to the receiving unit 11 already mentioned above, the control center 1 has a localization unit 12 which is designed to determine the location of the handheld transmitter 7. This is, in particular, a GPS localization unit which is used to evaluate a GPS satellite navigation location signal transmitted by the handheld transmitter 7. The control center 1 also comprises a communication unit 13 which is part of a person protection module 2. The person protection module 2 is designed to transmit corresponding emergency call signals, with the location information for example, to emergency services (52), a security service and/or to third parties, in particular family members of the person to be protected. The latter are expediently provided with additional handheld transmitters (sister handheld transmitters) 7′ in order to enable corresponding message transmission there.

In addition to the person protection module 2, the control center 1 has a property protection module 3. The property protection module 3 comprises a downlink interface 31 and an uplink interface 32. The uplink interface 32 is provided with a plurality of interface modules 34, 36. They are adapted to the data processing centers of financial institutions 53, in particular credit card companies or banks, and make it possible to block the accounts belonging to the person to be protected. The interface 36 is also designed to communicate with a database 54 of blocked cards (in particular check cards or other debit cards) in order to block the cards belonging to the person to be protected from withdrawals at a cash dispenser in this manner by entering said cards in the database 54.

The downlink interface 31 is designed to communicate with a motor vehicle 75 belonging to the person to be protected via a motor vehicle interface 35. This motor vehicle 75 has an immobilizer which can be wirelessly activated via the interface 35 of the downlink interface 31. This prevents, on the one hand, theft of the vehicle 75 from the estate belonging to the person to be protected and, in the case of possible abduction, also prevents the vehicle belonging to the person to be protected itself being used as a getaway vehicle. A building protection interface 37 is expediently also provided and is designed to communicate with the building 77 on the estate belonging to the person to be protected. When activated, it causes protection of the building and, in particular, closing of access routes such as the lowering of barriers or the closing of gates. Furthermore, the interface 37 can transmit a “silent” warning signal to the estate belonging to the person to be protected. This may involve the extinguishing of a lamp, which can be seen from outside the estate, or another operation (for example electrically caused pulling-down of a flag from the flagpole 78 on the estate) in order to thus provide a clearly visible signal to insiders. It is thus signaled to family members returning home that an alarm has been triggered. The family members returning home are therefore pre-warned and yet further family members are prevented from being involved in the matter, in particular in the case of threat scenarios such as abduction or hostage-taking.

A particularly convenient embodiment of the handheld transmitter 7, as illustrated in FIG. 3, is in the form of a watchstrap. A housing 76 is arranged on a watchstrap 74. The operating knobs 72, 72′, 72″ for the different emergency calls are arranged on the two side surfaces of said housing. If optionally equipped with a vitality sensor 81, the latter may be arranged on the underside of the housing 76 facing the body.

1. A protection system having a portable handheld transmitter assigned to a person to be protected and having at least one trigger and a transmitting unit for transmitting an emergency call signal, a control center comprising a receiving unit for receiving the emergency call signal from the handheld transmitter and a localization unit configured to determine a location of the handheld transmitter, and a communication unit configured to transmit a signal to an emergency service, the signal comprising details of the handheld transmitter and its location, wherein the control center has a person protection module and a property protection module the communication unit is connected at least to the person protection module, and the property protection module has an uplink interface which is configured to transmit blocking signals to financial institutions and also a downlink interface which is configured to send protection signals to a home base of the handheld transmitter.

2. The protection system of claim 1, wherein the handheld transmitter comprises a sensor for detecting a vital state and an automatic signal generator that automatically triggers the emergency call signal on the handheld transmitter under certain conditions.

3. The protection system of claim 2, comprising a standby switch having an expiration timer that, after being operated, automatically triggers the emergency call signal upon expiration if a cancel button has not previously been operated.

4. The protection system of claim 1, wherein the handheld transmitter is integrated in a wristwatch with a telephone function.

5. The protection system of claim 1, wherein the handheld transmitter has a plurality of input switches each of which signal different types of emergency calls.

6. The protection system of claim 5, wherein the plurality of input switches are operated by a common operating knob.

7. The protection system of claim 1, comprising sister handheld transmitters that are assigned to the portable handheld transmitter such that an alarm from one transmitter is signaled to the other transmitter.

8. The protection system of claim 1, wherein the control center comprises a two-part design with a control subcenter at the home location of the person to be protected.

9. The protection system of claim 8, wherein the control subcenter communicates with the control center via at least two independent communication paths, one of which is wireless and another of which is wired.

10. The protection system of claim 1, comprising a long timer that emits the emergency call again after expiry during an adjustable duration.

11. The protection system of claim 1, wherein the downlink interface is configured to communicate with the immobilizer of a motor vehicle and block said immobilizer using a signal.

12. The protection system of claim 1, wherein the downlink interface is configured to send a silent warning signal to a visibly state-variable device on a home base of the person to be protected.

13. A method for protecting persons or property using a portable transmitter comprising at least one trigger and a transmitting unit for transmitting an emergency call signal, a control center comprising a receiving unit for receiving the emergency call signal from the handheld transmitter, a localization unit and a communication unit, the control center comprising a person protection module, wherein the communication unit communicates at least with the person protection module, the method comprising:
assigning of the portable transmitter to a person to be protected,
determining a location of the portable transmitter,
transmitting a distress signal to an external emergency rescue service, the distress signal comprising details of the portable transmitter and its location,
generating and transmitting blocking signals via an uplink-interface to at least one property administering unit selected from a list comprising at least a bank, a credit card service and a cash dispensing service, and
sending protection signals via a downlink-interface to a home base assigned to the portable transmitter to operate at least one unit selected from a list comprising at least an on-site alarm system, a car immobilizer, and an access gate blocking device.

14. The method of claim 13, comprising detecting a vital state of the person to be protected and automatically checking and triggering of the distress signal on the handheld transmitter under certain conditions.

15. The method of claim 13, wherein a standby switch having an expiration timer is provided, and the timer, after being operated, automatically triggers the emergency call signal upon expiration if a cancel button has not previously been operated.

16. The method of claim 13, wherein the portable transmitter has a plurality of input switches each of which signals different types of emergency calls.

17. The method of claim 13, wherein at least one additional portable transmitter is provided and assigned to the portable handheld transmitter such that an alarm from one transmitter is signaled to the other transmitter.

18. The method of claim 13, wherein the control center comprises a two-part design with a control subcenter at the home location of the person to be protected, wherein the control subcenter communicates with the control center via at least two independent communication paths, one of which is wireless and another of which is wired.

19. The method of claim 13, wherein the downlink-interface communicates with the immobilizer of a motor vehicle and blocks said immobilizer using a signal.

20. The method of claim 13, wherein the downlink-interface issues a silent warning signal to a visibly state-variable device on a home base of the person to be protected.

21. The protection system of claim 10, wherein the timer emits the emergency call again after expiry during an adjustable duration in the hour range.

22. The protection system of claim 10, wherein the timer transmits a second emergency call signal.
